(19) United States
(12) Patent Application Publication
(10) Pub. No.: US 2014/0051022 A1
(43) Pub. Date: Feb. 20, 2014

(54) ELECTROSTATIC CHARGE IMAGE DEVELOPING CARRIER, ELECTROSTATIC CHARGE IMAGE DEVELOPER, PROCESS CARTRIDGE, IMAGE FORMING APPARATUS, AND IMAGE FORMING METHOD

(71) Applicant: FUJI XEROX CO., LTD., Tokyo (JP)

(72) Inventors: Takeshi SHOJI, Kanagawa (JP); Norihito FUKUSHIMA, Kanagawa (JP); Toshiaki HASEGAWA, Kanagawa (JP)

(73) Assignee: FUJI XEROX CO., LTD., Tokyo (JP)

(21) Appl. No.: 13/874,785

(22) Filed: May 1, 2013

(30) Foreign Application Priority Data
Aug. 16, 2012 (JP) 2012-180629

(51) Int. Cl. G03G 9/113; G03G 13/22

(52) U.S. Cl. CPC G03G 9/1133; G03G 13/22
USPC 430/110.2; 430/123.5; 399/119

(57) ABSTRACT

An electrostatic charge image developing carrier includes a core particle that has a BET specific surface area of from 0.15 m²/g to 0.30 m²/g; and a coating layer that contains a polycyclohexyl methacrylate resin and has a void ratio of from 2% to 10% and with which the core particle is coated, in which a content of a volatile organic compound is less than or equal to 500 ppm.

### CROSS-REFERENCE TO RELATED APPLICATIONS

This application is based on and claims priority under 35 USC 119 from Japanese Patent Application No. 2012-180629 filed Aug. 16, 2012.

### BACKGROUND

1. Technical Field

The present invention relates to an electrostatic charge image developing carrier, an electrostatic charge image developer, a process cartridge, an image forming apparatus, and an image forming method.

2. Related Art

In the related art, as an electrophotographic method, a method is used in which an electrostatic charge image is formed on a latent image holding member (photoreceptor) or an electrostatic recording medium using various kinds of units; and voltage-detection particles called toner are attached thereonto to develop the electrostatic charge image. In order to develop the electrostatic charge image, the toner and a carrier are mixed and are frictionally charged to impart an appropriate amount of positive or negative charge to the toner. In general, the carrier is broadly divided into a coated carrier having a coating layer on a surface thereof; and a non-coated carrier not having a coating film on a surface thereof. Among these, the coated carrier is superior in consideration of the lifetime of a developer and the like.

There are various properties required for the coated carrier. In particular, a property of imparting an appropriate charge amount (charge amount or charge distribution) to a toner and maintaining the charge amount for a long period of time is required. To that end, it is important that the charging properties of the toner are not changed depending on the impact resistance and abrasion resistance of the carrier, and environmental changes such as temperature, and humidity, and various coated carriers are disclosed.

### SUMMARY

According to an aspect of the invention, there is provided an electrostatic charge image developing carrier including core particle that has a BET specific surface area of from 0.15 m²/g to 0.30 m²/g; and a coating layer that contains a polycyclohexyl methacrylate resin and has a void ratio of from 2% to 10% and with which the core particle is coated, in which a content of a volatile organic compound is less than or equal to 500 ppm.

### BRIEF DESCRIPTION OF THE DRAWINGS

Exemplary embodiments of the present invention will be described in detail based on the following figures, wherein:

FIG. 1 is a diagram schematically illustrating a configuration of an image forming apparatus according to a first exemplary embodiment of the invention;

FIG. 2 is a diagram schematically illustrating a configuration of an image forming apparatus according to a second exemplary embodiment of the invention; and

FIG. 3 is a diagram schematically illustrating a configuration example of a process cartridge according to an exemplary embodiment of the invention.

### DETAILED DESCRIPTION

Hereinafter, an electrostatic charge image developing carrier, an electrostatic charge image developer, a process cartridge, an image forming apparatus, and an image forming method according to exemplary embodiments of the invention will be described in detail.

### Electrostatic Charge Image Developing Carrier

An electrostatic charge image developing carrier (hereinafter, also simply referred to as “carrier”) according to an exemplary embodiment of the invention includes a core particle that has a BET specific surface area of from 0.15 m²/g to 0.30 m²/g; and a coating layer that contains a polycyclohexyl methacrylate resin and has a void ratio of from 2% to 10% and with which the core particle is coated, in which a content of a volatile organic compound is less than or equal to 500 ppm.

In recent years, an electrophotographic method is used in various ways, and it may be required that a large number of images are continuously printed. When images are continuously printed using an electrophotographic method, a large amount of stress is applied to a carrier used. Therefore, a resin which forms a coating layer may be peeled off from a carrier having the coating layer. As a result, this peeled resin is attached onto a member, which causes deterioration in image quality. In order to suppress the peel-off, a configuration of roughening surfaces of the core particle to improve the strength of the coating film due to the anchor effect is attempted. However, in a wet method, voids are likely to be generated in a coating layer due to characteristics of the wet method and thus there is a case where the strength of the coating film is not improved.

On the other hand, an electrostatic charge image developing carrier prepared using a dry method does not contain a solvent such as toluene because the solvent such as toluene is not used in the preparation process. Therefore, the electrostatic charge image developing carrier prepared using a dry method has high environmental safety and the like and thus is currently in high demand, and the preparation using a dry method is important.

As a result of thorough investigation, the present inventors found that, when the above-described carrier according to the exemplary embodiment is used, image defects caused by the peeling of a coating layer are suppressed. The reason is not clear but is considered to be as follows.

Examples of a method of preparing a resin-coated carrier in which surfaces of core particles are coated with a resin include a wet method and a dry method. According to the wet method, the void ratio of a coating layer is lower than that of the dry method. Therefore, it is considered that the strength of a coating layer of a resin-coated carrier prepared using the wet method is higher than that of a coating layer of a resin-coated carrier prepared using the dry method. However, when the void ratio of a coating layer is low, the peeling of the coating layer is difficult to occur. However, once the peeling occurs, the scale thereof is large (that is, the size of each peeled piece is large) and a peeled coating layer may cause image defects. On the other hand, when the void ratio of a coating layer is large, the peeling of the coating layer easily occurs. However, the scale thereof is small (that is, the size of each peeled piece is small) and a peeled coating layer is not likely to cause image defects. For these reasons, it is considered that, when the carrier according to the exemplary embodiment is used, image defects caused by the peeling of a coating layer are suppressed.

In the carrier according to the exemplary embodiment, the core particles are coated with a coating layer containing a polycyclohexyl methacrylate resin. Since the polycyclohexyl methacrylate resin has low moisture absorbency, images are stably printed in a usage environment in which environmental changes are large.

The polycyclohexyl methacrylate resin used in this exemplary embodiment may be obtained by polymerization of cyclohexyl methacrylate alone; or may be a copolymer of cyclohexyl methacrylate and a monomer other than cyclohexyl methacrylate. When the polycyclohexyl methacrylate resin is the copolymer, the ratio of a repeating unit derived from cyclohexyl methacrylate to the polycyclohexyl methacrylate resin is preferably from 50% by mole to 100% by mole, more preferably from 70% by mole to 100% by mole, and still more preferably from 80% by mole to 100% by mole.

Examples of the monomer other than cyclohexyl methacrylate include styrene, acrylic acid, methacrylic acid, and alkyl methacrylate. Among these, methyl methacrylate is preferable.

When the molecular weight of the polycyclohexyl methacrylate resin is measured by gel permeation chromatography (GPC) (in terms of polystyrene), the weight average molecular weight (Mw) thereof is preferably from 10,000 to 100,000, more preferably from 30,000 to 90,000, and still more preferably from 40,000 to 80,000.

Optionally, in the coating layer of the carrier according to the exemplary embodiment, the polycyclohexyl methacrylate resin may be used in combination with a resin other than the polycyclohexyl methacrylate resin. Examples of the resin other than the polycyclohexyl methacrylate resin include polyolefin resins such as polyethylene and polypropylene; polyvinyl or polyvinylidene resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers and a styrene-acrylic acid copolymers; straight silicone resins having an organosiloxane bond or modified products thereof; fluororesins such as polytetrafluoroethylene, polyvinyl fluoride, polyvinylidene fluoride, and polychlorotrifluoroethylene; polyester; polyurethane; polycarbonate; amino resins such as urea-formaldehyde resin; and epoxy resins.

Among these, polyolefin resins, acrylic resins, and styrene-acrylic resins are preferably used.

When the polycyclohexyl methacrylate resin is used in combination with the resin other than the polycyclohexyl methacrylate resin, the ratio of the polycyclohexyl methacrylate resin to the coating layer is preferably from 50% by weight to 100% by weight, more preferably from 70% by weight to 100% by weight, and still more preferably from 80% by weight to 100% by weight. When the polycyclohexyl methacrylate resin is used in combination with the resin other than the polycyclohexyl methacrylate resin, the polycyclohexyl methacrylate resin may be obtained by polymerization of cyclohexyl methacrylate alone.

The carrier according to the exemplary embodiment is a resin-coated carrier including a core particle and a coating layer with which the resin particle is coated. Examples of the core particle used herein include particle of magnetic metals such as iron, steel, nickel, and cobalt; particle of magnetic oxides such as ferrite and magnetite; and glass bead.

The BET specific surface area of the core particle in this exemplary embodiment is from 0.15 m²/g to 0.30 m²/g. When the BET specific surface area of the core particle is less than 0.15 m²/g, there is a problem in that the coating layer is peeled off. On the other hand, when the BET specific surface area of the core particle is greater than 0.30 m²/g, the peeling of the coating layer does not easily occur. However, once the peeling occurs, the scale thereof may be large.

When the core particle having a BET specific surface area in the above-described range are used, the adhesion of the coating resin with the core particle can be secured due to the anchor effect and the deterioration in the strength of the coating layer is suppressed.

In the exemplary embodiment, measurement conditions of the BET specific surface area of the core particle are as follows.

The BET specific surface area is a value measured with a nitrogen substitution method. Specifically, the measurement is performed with a three-point method using a specific surface area measuring device SA3100 (manufactured by Beckman Coulter Inc.). 5 g of the core particles are put into a cell, followed by deaeration at 60° C. for 120 minutes. Then, the measurement is performed using mixed gas (volume ratio=30:70) of nitrogen and helium.

The void ratio of the coating layer according to the exemplary embodiment is from 2% to 10%, but is preferably from 2% to 9% and more preferably from 2% to 8%.

When the void ratio of the coating layer is less than 2%, the peeling of the coating layer does not easily occur. However, once the peeling occurs, the scale thereof may be large. On the other hand, when the void ratio of the coating layer is greater than 10%, the coating layer may be peeled off.

In the exemplary embodiment, a measurement method and measurement conditions of the void ratio of the coating layer are as follows.

Regarding carrier particle, a smooth cross-section of carrier is formed using a cross-section polisher (E-3500, manufactured by Hitachi Ltd.) and is imaged using FE-SEM (S4100, manufactured by Hitachi Ltd.) at a magnification of 1000 times; and the obtained image is analyzed using LUZEX III (manufactured by Nireco Corporation) to measure AREA-H (area of voids) and AREA (area of image). Then, the internal void ratio is obtained according to the following expression.

Internal Void Ratio (%)=100×AREA-H (Area Of Voids)/AREA (Area Of Image)

Examples of a method of forming the coating layer on the surfaces of the core particles does not include methods in which a solvent is used and removed later but include methods in which a solvent is not used such as a melt-kneading method of melting and kneading core particles with a coating resin and performing coating and a kneader coater method of mixing core particles with a coating resin in a kneader coater.

In this exemplary embodiment, these methods in which a solvent is not used are collectively referred to as “dry method” with respect to the methods (wet method) in which a solvent is used.

In the dry method according to the embodiment, the core particles and a resin material may be preliminarily stirred multiple times in advance in an environment of from 20° C. to 30° C. and then may be melted and kneaded. As a result, the voids in the coating layer are reduced and the strength of the coating layer is improved.

By adopting the dry method, the content of a volatile organic compound in the carrier according to the exemplary embodiment is easily adjusted to be less than or equal to 500 ppm. In the exemplary embodiment, the content of the volatile organic compound is preferably less than or equal to 300 ppm and more preferably less than or equal to 100 ppm. In addition, in order to suppress water absorbency, the content of the volatile organic compound is preferably greater than or equal to 10 ppm.

In the exemplary embodiment, a measurement method and measurement conditions of the content of the volatile organic compound of the carrier are as follows.

The concentration (content) of the volatile organic compound is measured using 2 g of carrier sample and a GC-2010 (gas chromatography-mass spectrometer, manufactured by Shimadzu Corporation).

The thickness of the coating layer of the carrier according to the exemplary embodiment is preferably from 0.1 μm to 10 μm and more preferably from 0.3 μm to 5 μm. The average particle diameter of the core particles of the carrier according to the exemplary embodiment is preferably from 10 μm to 500 μm and more preferably from 30 μm to 150 μm.

The volume average particle diameter of the carrier according to the exemplary embodiment is preferably from 15 μm to 510 μm.

In addition, in the coating layer of the carrier according to the exemplary embodiment, resin particles and the like may be used in combination for the purposes of charge control and the like. The resin particles are not particularly limited, but a charge-controlling material is preferable. Examples thereof include melamine resin particles, urea resin particles, urethane resin particles, polyester resin particles, and acrylic resin particles. Of these, melamine resin particles are preferably used.

In addition, in the coating layer of the carrier according to the exemplary embodiment, a conductive material such as carbon black may be used in combination for the purposes of resistance control and the like. Examples of the conductive material include, in addition to carbon black, metals such as gold, silver, and copper, titanium oxide, zinc oxide, tin oxide, barium sulfate, aluminum borate, potassium titanate, tin oxide doped with antimony, indium oxide doped with tin, zinc oxide doped with aluminum, and resin particles coated with a metal.

### Electrostatic Charge Image Developer

An electrostatic charge image developer (hereinafter, also simply referred to as “developer”) according to an exemplary embodiment of the invention contains the carrier and an electrostatic charge image developing toner (hereinafter, also simply referred to as “toner”) according to the exemplary embodiment. The developer according to the exemplary embodiment is prepared by mixing the carrier and the toner according to the exemplary embodiment at an appropriate mixing ratio. The content ((carrier)/(carrier toner)×100) of the carrier is preferably from 85% by weight to 99% by weight, more preferably from 87% by weight to 98% by weight, and still more preferably from 89% by weight to 97% by weight.

Hereinafter, the toner used for the developer according to the exemplary embodiment will be described.

The toner according to the exemplary embodiment contains a binder resin and a colorant as major components. Examples of the binder resin used include homopolymers or copolymers of styrenes such as styrene and chlorostyrene; monoolefines such as ethylene, propylene, butylene, and isobutylene; vinyl esters such as vinyl acetate, vinyl propionate, and vinyl benzoate; α-methylene aliphatic monocarboxylic acid esters such as methyl acrylate, ethyl acrylate, butyl acrylate, octyl acrylate, dodecyl acrylate, phenyl acrylate, methyl methacrylate, ethyl methacrylate, butyl methacrylate, and dodecyl methacrylate; vinyl ethers such as vinyl methyl ether, vinyl ethyl ether, and vinyl butyl ether; and vinyl ketones such as vinyl methyl ketone, vinyl hexyl ketone, and vinyl isopropenyl ketone.

In particular, representative examples of the binder resin include polystyrene, styrene-alkyl acrylate copolymers, styrene-alkyl methacrylate copolymers, styrene-acrylonitrile copolymers, styrene-butadiene copolymers, styrene-maleic anhydride copolymers, polyethylene, and polypropylene. Other examples thereof include polyester, polyurethane, epoxy resins, silicone resins, polyamide, modified rosin, paraffin, and waxes.

In the above-described binder resin, it is preferable that the softening point is from 70° C. to 150° C.; the glass transition temperature is from 40° C. to 70° C.; the number average molecular weight is from 2,000 to 50,000; the weight average molecular weight is from 8,000 to 150,000; the acid value is from 5 to 30; and the hydroxyl value is from 5 to 40.

Representative examples of the colorant of the toner include carbon black, nigrosine, aniline blue, calcoil blue, chrome yellow, ultramarine blue, DuPont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C.I. Pigment Yellow 12, C.I. Pigment Blue 15:1, and C.I. Pigment Blue 15:3.

Examples of a preparation method of toner particles include a kneading and pulverizing method in which the binder resin and the colorant (optionally, a release agent, a charge-controlling agent, and the like) are kneaded, pulverized, and classified; a method in which shapes of particles obtained using the kneading and pulverizing method are changed by mechanical shock or heat energy; an emulsion aggregation method in which a dispersion having the binder resin emulsified and dispersed therein and a dispersion having the colorant (optionally, a release agent, a charge-controlling agent, and the like) are mixed, aggregated, heated, and coalesced to obtain toner particles; an emulsion polymerization aggregation method in which a dispersion obtained by emulsifying and polymerizing a polymerizable monomer of the binder resin, and a dispersion having the colorant (optionally, a release agent, a charge-controlling agent and the like) are mixed, aggregated, heated, and coalesced to obtain toner particles; a suspension polymerization method in which a polymerizable monomer for obtaining the binder resin and a solution having the colorant (optionally, a release agent, a charge-controlling agent, and the like) are suspended in an aqueous solvent and polymerized; and a dissolving suspension method in which the binder resin and a solution having the colorant (optionally, a release agent, a charge-controlling agent, and the like) are suspended in an aqueous solvent and polymerized for granulation.

In addition, a preparation method may be used in which the toner particles obtained in the above method are used as a core and furthermore resin particles are attached, heated, and coalesced to have a core-shell structure. Among these, it is preferable that the toner according to the exemplary embodiment be toner (emulsion aggregation toner) obtained in the emulsion aggregation method or an emulsion polymerization aggregation method.

External additives may be added to these toner particles, for example, a fluidizer such as silica, titania, or alumina; or a cleaning aid or transfer aid such as polystyrene particles, polymethyl methacrylate particles, or polyvinylidene fluoride particles. The toner is obtained by adding the external additives to the toner particles. In particular, a hydrophobic silica having a primary average particle diameter of from 5 nm to 30 nm is preferably used.

In addition, examples of the external additives include charge-controlling agents such as salicylic acid metal salts, metal-containing azo compounds, nigrosines, quaternary ammonium salts; and offset inhibitors such as low-molecular-weight polypropylenes, low-molecular-weight polyethylenes, and high-molecular-weight alcohols. In particular, low-molecular-weight polypropylenes having a weight average molecular weight of from 500 to 5,000 are preferable. The average particle diameter of the toner according to the exemplary embodiment is less than or equal to 30 μm and preferably from 4 μm to 20 μm.

The shape factor SF1 of the toner according to the exemplary embodiment is preferably from 110 to 145, more preferably from 115 to 140, and still more preferably from 120 to 135. When the shape factor SF1 is from 110 to 145, an image having a high resolution is formed.

Numerical values of the shape factor SF1 are obtained by analyzing a microscopic image or a scanning electron microscopic image with an image analyzer. For example, the shape factor SF1 is obtained with the following method. In order to measure the shape factor SF1, first, an optical microscopic image of the toner dispersed on a slide glass is input to a LUZEX image analyzer through a video camera, shape factors SF1 of 50 or more particles are calculated according to the following expression, and the average value thereof is obtained.

SF1=(ML²/A)×(π/4)×100

In the expression, ML represents the absolute maximum length of particles, and A represents the projection area of particles.

### Image Forming Apparatus, Image Forming Method, and Process Cartridge

An image forming apparatus according to an exemplary embodiment of the invention includes a latent image holding member; a charging unit that charges a surface of the latent image holding member; an electrostatic charge image forming unit that forms an electrostatic charge image on a charged surface of the latent image holding member; a developing unit that develops the electrostatic charge image using the electrostatic charge image developer according to the exemplary embodiment to form a toner image; a transfer unit that transfers the toner image onto a recording medium; and a fixing unit that fixes the toner image on the recording medium. Optionally, the image forming apparatus according to the exemplary embodiment may further include a cleaning unit that removes toner remaining on the surface of the latent image holding member and the like.

In this image forming apparatus, for example, a portion including the developing unit may have a cartridge structure (process cartridge) which is detachable from an image forming apparatus main body. As the process cartridge, a process cartridge according to an exemplary embodiment of the invention is preferably used which is detachable from an image forming apparatus and includes at least one selected from the group consisting of a latent image holding member, a charging unit that charges a surface of the latent image holding member, and a cleaning unit that removes toner remaining on the surface of the latent image holding member; and a developing unit that accommodates the electrostatic charge image developer according to the exemplary embodiment and develops an electrostatic charge image, formed on the surface of the latent image holding member, using the electrostatic charge image developer to form a toner image.

An image forming method according to an exemplary embodiment of the invention, which is performed by the image forming apparatus according to the exemplary embodiment, includes charging a surface of a latent image holding member; forming an electrostatic charge image on a charged surface of the latent image holding member; developing the electrostatic charge image using the electrostatic charge image developer according to the exemplary embodiment to form a toner image; transferring the toner image onto a recording medium; and fixing the toner image on the recording medium.

Hereinafter, an example of the image forming apparatus according to the exemplary embodiment will be described. However, the image forming apparatus according to the exemplary embodiment is not limited thereto.

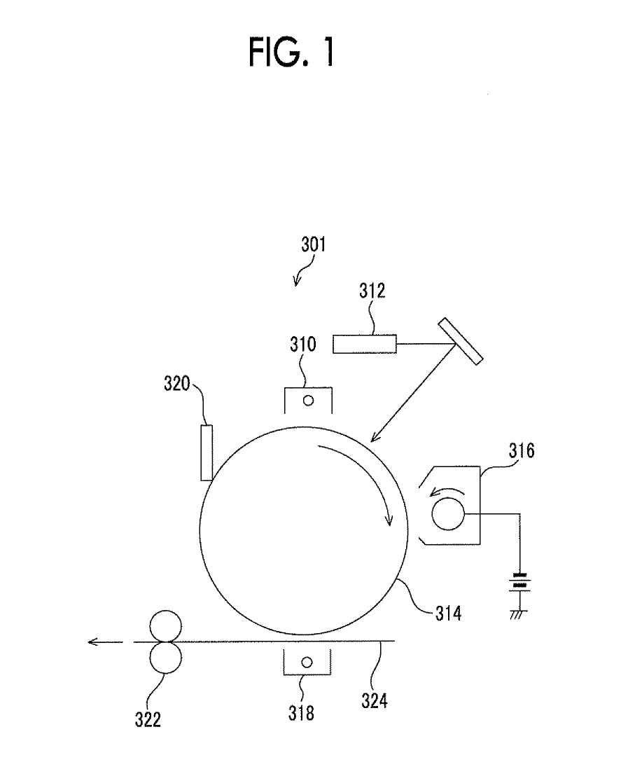

FIG. 1 is a diagram schematically illustrating a configuration of an image forming apparatus according to a first exemplary embodiment of the invention. An image forming apparatus 301 includes a charging portion 310, an exposure portion 312, an electrophotographic photoreceptor 314 which is the latent image holding member, a developing portion 316, a transfer portion 318, a cleaning portion 320, and a fixing portion 322.

In the image forming apparatus 301, around the electrophotographic photoreceptor 314, various components are arranged in the mentioned order, the various components including the charging portion 310 which is the charging unit that charges a surface of the electrophotographic photoreceptor 314; the exposure portion 312 which is the electrostatic charge image forming unit that exposes the charged surface of the electrophotographic photoreceptor 314 to light to form an electrostatic charge image according to image information; the developing portion 316 which is the developing unit that develops the electrostatic charge image using the developer to form a toner image; the transfer portion 318 which is the transfer unit that transfers the toner image, formed on the surface of the electrophotographic photoreceptor 314, onto a recording medium 324; and the cleaning portion 320 which is the cleaning unit that removes foreign materials such as toner remaining on the surface of the electrophotographic photoreceptor 314 after transferring the toner image to clean the surface of the electrophotographic photoreceptor 314. In addition, the fixing portion 322, which is the fixing unit that fixes the toner image transferred onto the recording medium 324, is arranged laterally to the transfer portion 318.

The operation of the image forming apparatus 301 according to the exemplary embodiment will be described. First, the surface of the electrophotographic photoreceptor 314 is charged by the charging portion 310 (charging step). Next, the surface of the electrophotographic photoreceptor 314 is irradiated with light by the exposure portion 312, the charge of light-irradiated portions is erased, and an electrostatic charge image is formed according to image information (electrostatic charge image forming step). Then, the electrostatic charge image is developed by the developing portion 316 and thus a toner image is formed on the surface of the electrophotographic photoreceptor 314 (developing step). For example, in a digital electrophotographic copying machine in which an organic photoreceptor is used as the electrophotographic photoreceptor 314 and a laser beam light source is used as the exposure portion 312, the surface of the electrophotographic photoreceptor 314 is negatively charged by the charging portion 310, a dot-like digital latent image is formed by laser beams, and the toner is attached onto portions, irradiated with the laser beams, by the developing portion 316, thereby visualizing the latent image. In this case, a negative bias is applied to the developing portion 316. Next, in the transfer portion 318, the recording medium 324 such as paper is made to overlap the toner image, a charge having a polarity opposite to that of the toner is applied to the recording medium 324 from the back side of the recording medium 324, and the toner image is transferred onto the recording medium 324 due to an electrostatic force (transfer step). Heat and pressure is applied to the transferred toner image by fixing members of the fixing portion 322 to fix the toner image on the recording medium 324 (fixing step). Meanwhile, foreign materials such as toner which are not transferred and remain on the surface of the electrophotographic photoreceptor 314 are removed by the cleaning portion 320 (cleaning step). When a series of the charging to cleaning steps are finished, one cycle is finished. In FIG. 1, the toner image is directly transferred onto the recording medium 324 such as paper by the transfer portion 318, but may be transferred thereonto through a transfer medium such as an intermediate transfer medium.

Hereinafter, the charging unit, the latent image holding member, the electrostatic charge image forming unit (exposure unit), the developing unit, the transfer unit, the cleaning unit, and the fixing unit of the image forming apparatus 301 illustrated in FIG. 1 will be described.

### Charging Unit

As the charging portion 310 which is the charging unit, for example, a corotron charger may be used as illustrated in FIG. 1, but a conductive or semi-conductive charging roller may be used. A contact-type charger using the conductive or semi-conductive charging roller may apply a direct current to the electrophotographic photoreceptor 314; or may superimpose an alternating current to be applied thereto. For example, electric discharge is generated by the charging unit 310 in a small space in the vicinity of a contact portion with the electrophotographic photoreceptor 314, thereby charging the surface of the electrophotographic photoreceptor 314. Normally, the surface of the electrophotographic photoreceptor 314 is charged in a range of from −300 V to −1000 V. In addition, the above-described conductive or semi-conductive charging roller may have a single-layer structure or a multi-layer structure. In addition, a mechanism for cleaning a surface of the charging roller may be provided.

### Latent Image Holding Member

The latent image holding member has at least a function of forming a latent image (electrostatic charge image). As the latent image holding member, for example, an electrophotographic photoreceptor is preferably used. The electrophotographic photoreceptor 314 has a coating film including an organic photoreceptor and the like on an outer peripheral surface of a cylindrical conductive substrate. The coating film is obtained by forming, optionally, an undercoat layer and a photosensitive layer, which includes a charge generating layer containing a charge generating material and charge transporting layer containing a charge transporting material, on the substrate in this order. The lamination order of the charge generating layer and the charge transporting layer may be reversed. A multi-layer photoreceptor in which separate layers (charge generating layer and charge transporting layer) contain a charge generating material and a charge transporting material, respectively, and are laminated may be used; or a single-layer photoreceptor in which a single layer contains both a charge generating material and a charge transporting material may be used. Among these, the multi-layer photoreceptor is preferable. In addition, an interlayer may be provided between the undercoat layer and the photosensitive layer. In addition, the electrophotographic photoreceptor is not limited to the organic photoreceptor. Other kinds of photosensitive layers such as an amorphous silicon photosensitive film may be used.

### Electrostatic Charge Image Forming Unit

The exposure portion 312 which is the electrostatic charge image forming unit (exposure unit) is not particularly limited. For example, an optical device of exposing the surface of the latent image holding member to semiconductor laser light, LED light, liquid crystal shutter light, or the like, emitted from a light source, according to a desired image shape.

### Developing Unit

The developing portion 316 which is the developing unit has a function of developing the latent image, formed on the latent image holding member, using the developer containing the toner to form a toner image. Such a developing device is not particularly limited as long as it has the above-described function, and may be selected according to the purpose. For example, a well-known developing unit which has a function of attaching the electrostatic charge image developing toner onto the electrophotographic photoreceptor 314 using a brush, a roller, or the like may be used. In the electrophotographic photoreceptor 314, a DC voltage may be normally used, but an AC voltage may be further superimposed and used.

### Transfer Unit

As the transfer portion 318 which is the transfer unit, for example, as shown in FIG. 1, a transfer device in which a charge having a polarity opposite to that of the toner is applied to the recording medium 324 from the back side of the recording medium 324 and the toner image is transferred onto the recording medium 324 due to an electrostatic force; or a transfer roller and a transfer roller pressing device using the conductive or semi-conductive roller or the like which contacts directly with the recording medium 324 to transfer the toner image onto the recording medium, may be used. To the transfer roller, as a transfer voltage which is applied to the latent image holding member, a direct current may be applied or an alternating current may be superimposed and applied. The transfer roller may be set based on the width of an image region to be charged, the shape of a transfer charger, the open width, the process speed (peripheral speed), and the like. In addition, in order to reduce costs, a single-layer foamed roller or the like is preferably used as the transfer roller. As the transfer method, a method of directly transferring the toner image onto the recording medium 324 such as paper; or a method of transferring the toner image onto the recording medium 324 through an intermediate transfer medium may be used.

As the intermediate transfer medium, a well-known intermediate transfer medium may be used. Examples of a material used for the intermediate transfer medium include polycarbonate (PC) resins, polyvinylidene fluoride (PVDF), polyalkylene phthalate, a blended material of PC and polyalkylene terephthalate (PAT), a blended material of ethylene tetrafluoroethylene (ETFE) copolymer and PC, a blended material of ETFE and PAT, and a blended material of PC and PAT. Among these, an intermediate transfer belt using a thermosetting polyimide resin is preferable from the viewpoint of mechanical strength.

### Cleaning Unit

As the cleaning portion 320 which is the cleaning unit, any one of a blade cleaning type, a brush cleaning type, and a roller cleaning type may be selected and use as long as it cleans foreign materials such as toner remaining on the latent image holding member.

### Fixing Unit

The fixing portion 322 which is the fixing unit (image fixing device) fixes the toner image, transferred onto the recording medium 324, by applying either or both of heat and pressure, and is provided with fixing members.

### Recording Medium

Examples of the recording medium 324 onto which the toner image is transferred include plain paper and OHP sheet which are used for an electrophotographic copying machine, printer, or the like. In order to further improve the smoothness of a fixed image surface, it is preferable that the surface of the recording medium be also smooth. For example, coated paper obtained by coating a surface of plain paper with a resin or art paper for printing may be used.

In addition, by using a trickle phenomenon described in JP-B-2-21591 in combination, images are stably formed for a longer period of time.

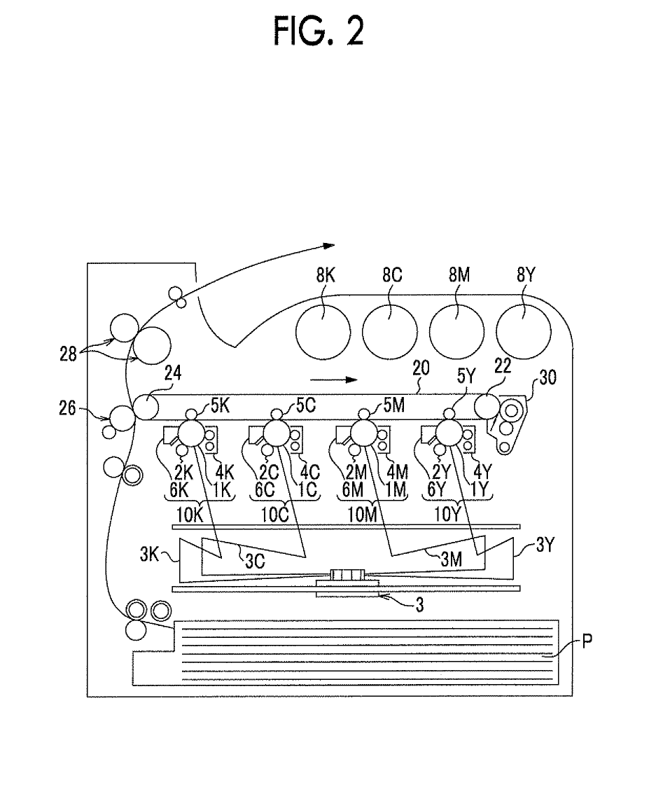

FIG. 2 is a diagram schematically illustrating a four tandem type color image forming apparatus which is an image forming apparatus according to a second exemplary embodiment of the invention. The image forming apparatus illustrated in FIG. 2 includes electrophotographic first to fourth image forming units 10Y, 10M, 10C, and 10K that print respective color images of yellow (Y), magenta (M), cyan (C), and black (K) based on color-separated image data. These image forming units (hereinafter, also simply referred to as “units”) 10Y, 10M, 10C, and 10K are arranged parallel to each other at predetermined intervals in a horizontal direction. These units 10Y, 10M, 10C, and 10K may be a process cartridge which is detachable from an image forming apparatus main body.

In an upper region of the respective units 10Y, 10M, 10C, and 10K of the drawing, an intermediate transfer belt 20 as the intermediate transfer medium extends through the respective units. The intermediate transfer belt 20 is wound around a driving roller 22 and a support roller 24 in contact with the inside of the intermediate transfer belt 20 which are arranged distant from each other in a direction from left to right of the drawing. The intermediate transfer belt 20 moves in a direction from the first unit 10Y to the fourth unit 10K. A force is applied to the support roller 24 by a spring (not illustrated) in a direction away from the driving roller 22. The tension is applied to the intermediate transfer belt 20 that is wound around both of the rollers. In addition, on the latent image holding member side of the intermediate transfer belt 20, an intermediate transfer medium cleaning device 30 is provided opposite the driving roller 22.

In addition, four color toners of yellow, magenta, cyan, and black that are accommodated in toner cartridges 8Y, 8M, 8C, and 8K are respectively supplied to developing devices (developing units) 4Y, 4M, 4C, and 4K of the respective units 10Y, 10M, 10C, and 10K.

The above-described first to fourth units 10Y, 10M, 10C, and 10K have the same configuration. Therefore, the first unit 10Y which is arranged on the upstream side in the moving direction of the intermediate transfer belt and forms a yellow image will be described as a representative example. The description of the second to fourth units 10M, 10C, and 10K will not be repeated by attaching, instead of Y (yellow), M (magenta), C (cyan), and K (black) to reference numerals of the same components of the first unit 10Y.

The first unit 10Y includes a photoreceptor 1Y that functions as the latent image holding member. Around the photoreceptor 1Y, various components are arranged in the mentioned order, the various components including a charging roller 2Y that charges a surface of the photoreceptor 1Y to a predetermined potential; an exposure device (electrostatic charge image forming unit) 3 that exposes the charged surface to laser beams 3Y, based on color-separated image signals to form an electrostatic charge image; a developing device (developing unit) 4Y that supplies a charged toner to the electrostatic charge image to develop the electrostatic charge image; a primary transfer roller (primary transfer unit) 5Y that transfers the developed toner image onto the intermediate transfer belt 20; and a photoreceptor cleaning device (cleaning unit) 6Y that removes toner remaining on the surface of the photoreceptor 1Y after the primary transfer.

The primary transfer roller 5Y is arranged inside the intermediate transfer belt 20 at a position opposite the photoreceptor 1Y. Furthermore, bias power supplies (not illustrated) that supply primary transfer biases are connected to the respective primary transfer rollers 5Y, 5M, 5C, and 5K. A controller (not illustrated) controls the respective bias power supplies to change transfer biases which are applied to the respective primary transfer rollers.

Hereinafter, in the first unit 10Y, the operation of forming a yellow image will be described. First, before the operation, the surface of the photoreceptor 1Y is charged to a potential of approximately −600 V to −800 V by the charging roller 2Y.

The photoreceptor 1Y is formed by laminating a photosensitive layer on a conductive substrate (volume resistivity at 20° C.: 1×10⁻⁶ Ω·cm or less). This photosensitive layer normally has a high resistance (a same resistance as that of a general resin). However, the photosensitive layer has a property in which, when being irradiated with the laser beams 3Y, the specific resistance of laser-irradiated portions is changed. In this case, the charged surface of the photoreceptor 1Y is irradiated with the laser beams 3Y output from the exposure device 3 based on yellow image data transmitted from a controller (not illustrated). The laser beams 3Y are radiated on the photosensitive layer of the surface of the photoreceptor 1Y to form an electrostatic charge image having a yellow print pattern on the surface of the photoreceptor 1Y.

The electrostatic charge image is an image which is formed on the surface of photoreceptor 1Y by charging, and is a so-called negative latent image which is formed through a process in which the specific resistance of the laser-irradiated portions of the photosensitive layer is reduced by the laser beams 3Y and thus the charge flows through the surface of the photoreceptor 1Y; and, on the other hand, the charge remains on portions not irradiated with the laser beams 3Y.

The electrostatic charge image, formed on the photoreceptor 1Y in this way, is rotated to a predetermined development position along with the movement of the photoreceptor 1Y. On this development position, the electrostatic charge image formed on the photoreceptor 1Y is visualized (developed) by the developing device 4Y.

The developing device 4Y accommodates, for example, an electrostatic charge image developer including at least a yellow toner and a carrier. The yellow toner is frictionally charged by being agitated in the developing device 4Y, has a charge having the same polarity (negative polarity) as that of the charge on the photoreceptor 1Y, and is held on a developer roller (developer holder). When the surface of the photoreceptor 1Y passes through the developing device 4Y, the yellow toner is electrostatically attached onto a charge-erased latent image portion on the surface of the photoreceptor 1Y and thus a latent image is developed by the yellow toner.

From the viewpoints of development efficiency, image graininess, tone reproduction, and the like, a bias voltage (developing bias) in which an AC component is superimposed on a DC component may be applied to the developer holder. Specifically, when a DC voltage Vdc to be applied to the developer holder is from −300 V to −700 V, the peak width Vp-p of an AC voltage to be applied to the developer holder may be set in a range of from 0.5 kV to 2.0 kV.

Next, the photoreceptor 1Y on which the yellow toner image is formed moves continuously at a predetermined speed to transport the toner image, developed on the photoreceptor 1Y, to a predetermined primary transfer position.

When the yellow toner image on the photoreceptor 1Y is transported to the primary transfer position, a primary transfer bias is applied to the primary transfer roller 5Y, an electrostatic force directed from the photoreceptor 1Y to the primary transfer roller 5Y is applied to the toner image, and thus the toner image on the photoreceptor 1Y is transferred onto the intermediate transfer belt 20. At this time, the applied transfer bias has the positive polarity opposite to the negative polarity of the toner. For example, in the first unit 10Y, the applied transfer bias is controlled to approximately 10 μA by a controller (not illustrated).

Meanwhile, toner remaining on the photoreceptor 1Y is removed and collected by the cleaning device 6Y.

In addition, the primary transfer biases which are applied to the primary transfer rollers 5M, 5C, and 5K of the second unit 10M and the subsequent units are controlled based on the first unit.

In this way, the intermediate transfer belt 20, onto which the yellow toner image is transferred by the first unit 10Y, is sequentially transported to the second to fourth units 10M, 10C, and 10K, and the toner images in respective colors are superimposed and multi-transferred.

The intermediate transfer belt 20, onto which the four color toner images are multi-transferred by the first to fourth units, reaches a secondary transfer portion including the intermediate transfer belt 20, the support roller 24 in contact with the inner surface of the intermediate transfer belt, and the secondary transfer roller (secondary transfer unit) 26 that is arranged on an image holding surface side of the intermediate transfer belt 20. Meanwhile, a recording paper (recording medium) P is fed by a supply mechanism at a predetermined timing to a gap where the secondary transfer roller 26 is pressed against the intermediate transfer belt 20, and a secondary transfer bias is applied to the support roller 24. At this time, the applied transfer bias has the negative polarity which is the same as the negative polarity of the toner. An electrostatic force directed from the intermediate transfer belt 20 to the recording paper P acts on the toner image, and thus the toner image on the intermediate transfer belt 20 is transferred onto the recording paper P. At this time, the secondary transfer bias is determined based on the resistance detected by a resistance detecting unit (not illustrated) which detects the resistance of the secondary transfer portion, and is voltage-controlled.

Then, the recording paper P is transported to a pressure-contact portion (nip portion) of a pair of fixing rollers in the fixing device (roller fixing unit) 28 to heat the toner image, and the multi-transferred color toner image is coalesced and fixed on the recording paper P.

Examples of the recording medium onto which the toner image is transferred include plain paper and OHP sheet which are used for an electrophotographic copying machine, printer, or the like.

The recording paper P on which the color images are fixed is transported to a discharge portion, and a series of color image forming operations is finished.

The image forming apparatus described above as an example has a configuration in which the toner image is transferred onto the recording medium P through the intermediate transfer belt 20, but the image forming apparatus is not limited to this configuration. The toner image may be directly transferred onto the recording medium from the photoreceptor.

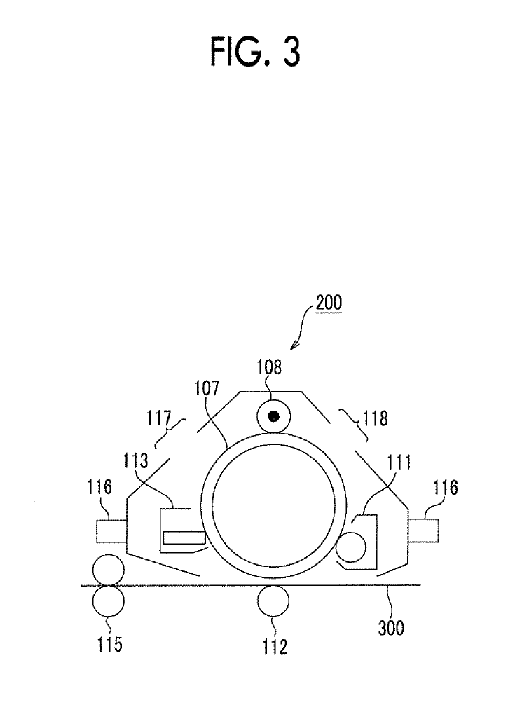

FIG. 3 is a diagram schematically illustrating a preferable configuration example of a process cartridge that accommodates the electrostatic charge image developer according to the exemplary embodiment. The process cartridge 200 is obtained by combining, in addition to a developing device 111, a photoreceptor 107, a charging device (a charging roller) 108, a photoreceptor cleaning device 113, an exposure opening 118, and an exposure opening for erasing 117 with each other using a mounting rail 116. In FIG. 2, reference numeral 300 represents a recording medium.

This process cartridge 200 is detachable from an image forming apparatus main body including a transfer device 112, a fixing device 115, and other components (not illustrated); and forms an image forming apparatus with the image forming apparatus main body.

The process cartridge 200 illustrated in FIG. 3 include the photoreceptor 107, the charging device 108, the developing device 111, the cleaning device 113, the exposure opening 118, and the exposure opening for erasing 117. However, these devices may be selectively combined. The process cartridge according to the exemplary embodiment may include the developing device 111 and at least one selected from a group consisting of the photoreceptor 107, the charging device 108, and the cleaning device (cleaning unit) 113.

Next, a toner cartridge will be described. The toner cartridge is detachably mounted on an image forming apparatus and accommodates at least a toner which is supplied to the developing unit provided in the image forming apparatus. The toner cartridge is not particularly limited as long as it accommodates at least the toner, and may accommodate, for example, a developer depending on the mechanism of an image forming apparatus.

The image forming apparatus illustrated in FIG. 2 has a configuration in which toner cartridges 8Y, 8M, 8C, and 8K are detachable therefrom. Developing devices 4Y, 4M, 4C, and 4K are connected to the toner cartridges corresponding to the respective developing devices (colors) through toner supply tubes (not illustrated). In addition, when the amount of a toner accommodated in a toner cartridge is small, this toner cartridge is replaced with a new one.

### EXAMPLES

Hereinafter, the exemplary embodiments will be described in further detail using Examples and Comparative Examples. However, the exemplary embodiments are not limited to the Examples. “Part(s)” and “%” represent “part(s) by weight” and “% by weight” unless specified otherwise.

### Preparation of Carrier 1

Ferrite particles (manufactured by Powdertech Co., Ltd., BET specific surface area: 0.20 m²/g, average particle diameter: 50 μm): 100 parts

Polycyclohexyl methacrylate resin (manufactured by Sekisui Plastics Co., Ltd., weight average molecular weight: 60,000, ratio of a repeating unit derived from cyclohexyl methacrylate: 100% by mole): 0.8 part

Resin particles (melamine resin particles, volume average particle diameter: 100 nm): 0.3 part

The above-described components are put into a Henschel mixer, followed by stirring and mixing at 1200 rpm and 22° C. for 10 minutes. As a result, resin-coated particles 1A are prepared. Next, the following materials are further added to the obtained resin-coated particles 1A. The resultant is put into a Henschel mixer, followed by stirring and mixing at 1200 rpm for 10 minutes. As a result, resin-coated particles 1B are prepared.

Polycyclohexyl methacrylate resin (manufactured by Sekisui Plastics Co., Ltd., weight average molecular weight: 60,000, ratio of a repeating unit derived from cyclohexyl methacrylate: 100% by mole): 1 part

Resin particles (melamine resin particles, volume average particle diameter: 100 nm): 0.3 part

Next, the following materials are further added to the obtained resin-coated particles 1B. The resultant is put into a Henschel mixer, followed by stirring and mixing at 1200 rpm for 10 minutes. As a result, resin-coated particles 1C are prepared. During stirring and mixing, the temperature is continuously increased, and the temperature is 26° C. when stirring and mixing is finished.

Polycyclohexyl methacrylate resin (manufactured by Sekisui Plastics Co., Ltd., weight average molecular weight: 60,000, ratio of a repeating unit derived from cyclohexyl methacrylate: 100% by mole): 1 part

Resin particles (melamine resin particles, volume average particle diameter: 100 nm): 0.3 part

Next, the obtained resin-coated particles 1C are stirred for 30 minutes in a kneader, in which the temperature is maintained at 200° C., and then are cooled to 25° C. to form a coating layer. As a result, a carrier 1 is obtained. The void ratio of the coating layer of the obtained carrier 1 is 3.5%. In addition, the content of a volatile organic compound in the carrier 1 is 250 ppm.

### Preparation of Carrier 2

A carrier 2 is prepared with the same preparation method as that of the carrier 1, except that polycyclohexyl methacrylate resin and polymethyl methacrylate resin (manufactured by Soken Engineering Co., Ltd., weight average molecular weight: 70,000) are used at a weight ratio of 82:18 instead of polycyclohexyl methacrylate resin alone used for the preparation of the carrier 1. The amount of polycyclohexyl methacrylate resin used is 2.30 parts, and the amount of polymethyl methacrylate resin used is 0.50 part. During stirring, the start temperature is 22° C. and the finish temperature is 28° C.

The void ratio of the coating layer of the carrier 2 is 3.7%. In addition, the content of a volatile organic compound in the carrier 2 is 260 ppm.

### Preparation of Carrier 3

A carrier 3 is prepared with the same preparation method as that of the carrier 2, except that the weight ratio of polycyclohexyl methacrylate resin and polymethyl methacrylate resin used for the preparation of the carrier 2 is changed to 78:22. The amount of polycyclohexyl methacrylate resin used is 2.18 parts, and the amount of polymethyl methacrylate resin used is 0.62 part. During stirring, the start temperature is 23° C. and the finish temperature is 29° C.

The void ratio of the coating layer of the carrier 3 is 3.6%. In addition, the content of a volatile organic compound in the carrier 3 is 270 ppm.

### Preparation of Carrier 4

A carrier 4 is prepared with the same preparation method as that of the carrier 2, except that the weight ratio of polycyclohexyl methacrylate resin and polymethyl methacrylate resin used for the preparation of the carrier 2 is changed to 72:28. The amount of polycyclohexyl methacrylate resin used is 2.02 parts, and the amount of polymethyl methacrylate resin used is 0.78 part. During stirring, the start temperature is 22° C. and the finish temperature is 28° C.

The void ratio of the coating layer of the carrier 4 is 3.5%. In addition, the content of a volatile organic compound in the carrier 4 is 260 ppm.

### Preparation of Carrier 5

A carrier 5 is prepared with the same preparation method as that of the carrier 2, except that the weight ratio of polycyclohexyl methacrylate resin and polymethyl methacrylate resin used for the preparation of the carrier 2 is changed to 67:33. The amount of polycyclohexyl methacrylate resin used is 1.88 parts, and the amount of polymethyl methacrylate resin used is 0.92 part. During stirring, the start temperature is 21° C. and the finish temperature is 26° C.

The void ratio of the coating layer of the carrier 5 is 3.2%. In addition, the content of a volatile organic compound in the carrier 5 is 270 ppm.

### Preparation of Carrier 6

A carrier 6 is prepared with the same preparation method as that of the carrier 2, except that the weight ratio of polycyclohexyl methacrylate resin and polymethyl methacrylate resin used for the preparation of the carrier 2 is changed to 52:48. The amount of polycyclohexyl methacrylate resin used is 1.46 parts, and the amount of polymethyl methacrylate resin used is 1.34 parts. During stirring, the start temperature is 22° C. and the finish temperature is 27° C.

The void ratio of the coating layer of the carrier 6 is 3.1%. In addition, the content of a volatile organic compound in the carrier 6 is 240 ppm.

### Preparation of Carrier 7

A carrier 7 is prepared with the same preparation method as that of the carrier 2, except that the weight ratio of polycyclohexyl methacrylate resin and polymethyl methacrylate resin used for the preparation of the carrier 2 is changed to 47:53. The amount of polycyclohexyl methacrylate resin used is 1.32 parts, and the amount of polymethyl methacrylate resin used is 1.48 parts. During stirring, the start temperature is 23° C. and the finish temperature is 27° C.

The void ratio of the coating layer of the carrier 7 is 3.0%. In addition, the content of a volatile organic compound in the carrier 7 is 230 ppm.

### Preparation of Carrier 8

Ferrite particles (manufactured by Powdertech Co., Ltd., BET specific surface area: 0.28 m²/g, average particle diameter: 35 μm): 100 parts

Polycyclohexyl methacrylate resin (manufactured by Sekisui Plastics Co., Ltd., weight average molecular weight: 40,000, ratio of a repeating unit derived from cyclohexyl methacrylate: 90% by mole, ratio of a repeating unit derived from methyl methacrylate: 10% by mole): 1.4 parts

Resin particles (melamine resin particles, volume average particle diameter: 100 nm): 0.3 part

The above-described components are put into a Henschel mixer, followed by stirring and mixing at 500 rpm and 22° C. for 20 minutes. As a result, resin-coated particles 2A are prepared. Next, the following materials are further added to the obtained resin-coated particles 2A. The resultant is put into a Henschel mixer, followed by stirring and mixing at 500 rpm for 20 minutes. As a result, resin-coated particles 2B are prepared.

Polycyclohexyl methacrylate resin (manufactured by Sekisui Plastics Co., Ltd., weight average molecular weight: 40,000, ratio of a repeating unit derived from cyclohexyl methacrylate: 90% by mole, ratio of a repeating unit derived from methyl methacrylate: 10% by mole): 1.4 parts

Resin particles (melamine resin particles, volume average particle diameter: 100 nm): 0.3 part

Next, the following materials are further added to the obtained resin-coated particles 2B. The resultant is put into a Henschel mixer, followed by stirring and mixing at 500 rpm for 20 minutes. As a result, resin-coated particles 2C are prepared. During stirring and mixing, the temperature is continuously increased, and the temperature is 24° C. when stirring and mixing is finished.

Polycyclohexyl methacrylate resin (manufactured by Sekisui Plastics Co., Ltd., weight average molecular weight: 40,000, ratio of a repeating unit derived from cyclohexyl methacrylate: 90% by mole, ratio of a repeating unit derived from methyl methacrylate: 10% by mole): 1.4 parts

Resin particles (melamine resin particles, volume average particle diameter: 100 nm): 0.3 part

Next, the obtained resin-coated particles 2C are stirred for 30 minutes in a kneader, in which the temperature is maintained at 150° C., and then are cooled to 25° C. to form a coating layer. As a result, a carrier 8 is obtained. The void ratio of the coating layer of the obtained carrier 8 is 5.0%. In addition, the content of a volatile organic compound in the carrier 8 is 300 ppm.

### Preparation of Carrier 9

A carrier 9 is prepared with the same preparation method as that of the carrier 1, except that melamine resin particles are not used.

The void ratio of the coating layer of the carrier 9 is 3.5%. In addition, the content of a volatile organic compound in the carrier 9 is 250 ppm. During stirring, the start temperature is 22° C. and the finish temperature is 28° C.

### Preparation of Carrier 10

Ferrite particles (manufactured by Powdertech Co., Ltd., BET specific surface area: 0.20 m²/g, average particle diameter: 50 μm): 100 parts

Polycyclohexyl methacrylate resin (manufactured by Sekisui Plastics Co., Ltd., weight average molecular weight: 60,000, ratio of a repeating unit derived from cyclohexyl methacrylate: 100% by mole): 2.4 parts

Resin particles (melamine resin particles, volume average particle diameter: 100 nm): 0.9 part

The above-described components are put into a Henschel mixer, followed by stirring and mixing at 1200 rpm and 22° C. for 10 minutes. As a result, resin-coated particles 3A are prepared. During stirring, the finish temperature is 28° C. Next, the obtained resin-coated particles 3A are stirred for 30 minutes in a kneader, in which the temperature is maintained at 200° C., and then are cooled to 25° C. to form a coating layer. As a result, a carrier 10 is obtained. The void ratio of the coating layer of the obtained carrier 10 is 15%. In addition, the content of a volatile organic compound in the carrier 10 is 260 ppm.

### Preparation of Carrier 11

Ferrite particles (manufactured by Powdertech Co., Ltd., BET specific surface area: 0.20 m²/g, average particle diameter: 50 μl): 100 parts

Toluene: 10 parts

Polycyclohexyl methacrylate resin (manufactured by Sekisui Plastics Co., Ltd., weight average molecular weight: 40,000, ratio of a repeating unit derived from cyclohexyl methacrylate: 90% by mole, ratio of a repeating unit derived from methyl methacrylate: 10% by mole): 2.4 parts

Resin particles (melamine resin particles, volume average particle diameter: 100 nm): 0.9 part

The above-described components other than the ferrite particles are dispersed for 10 minutes using a homomixer to prepare a coating layer-forming toluene solution. This toluene solution and the ferrite particles are stirred in a vacuum deaeration type kneader, in which the temperature is maintained at 60° C., for 30 minutes. The pressure is reduced to 5 kPa for 60 minutes and toluene is distilled away to form a coating layer. As a result, a carrier 11 is obtained. The void ratio of the coating layer of the obtained carrier 11 is 1.2%. In addition, the content of a volatile organic compound in the carrier 11 is 520 ppm.

### Preparation of Carrier 12

A carrier 12 is prepared with the same preparation method as that of the carrier 1, except that 100 parts of ferrite particles (manufactured by Powdertech Co., Ltd., BET specific surface area: 0.11 m²/g, average particle diameter: 50 μm) is used. During stirring, the start temperature is 22° C. and the finish temperature is 28° C.

The void ratio of the coating layer of the obtained carrier 12 is 11%. In addition, the content of a volatile organic compound in the carrier 12 is 280 ppm.

### Preparation of Carrier 13

A carrier 13 is prepared with the same preparation method as that of the carrier 1, except that 100 parts of ferrite particles (manufactured by Powdertech Co., Ltd., BET specific surface area: 0.17 m²/g, average particle diameter: 50 μm) is used. During stirring, the start temperature is 23° C. and the finish temperature is 29° C. The void ratio of the coating layer of the obtained carrier 13 is 9%. In addition, the content of a volatile organic compound in the carrier 13 is 280 ppm.

### Preparation of Carrier 14

A carrier 14 is prepared with the same preparation method as that of the carrier 1, except that 100 parts of ferrite particles (manufactured by Powdertech Co., Ltd., BET specific surface area: 0.28 m²/g, average particle diameter: 50 μm) is used. During stirring, the start temperature is 22° C. and the finish temperature is 28° C. The void ratio of the coating layer of the obtained carrier 14 is 3%. In addition, the content of a volatile organic compound in the carrier 14 is 310 ppm.

### Preparation of Carrier 15

A carrier 15 is prepared with the same preparation method as that of the carrier 1, except that 100 parts of ferrite particles (manufactured by Powdertech Co., Ltd., BET specific surface area: 0.38 m²/g, average particle diameter: 50 μm) is used. During stirring, the start temperature is 22° C. and the finish temperature is 28° C. The void ratio of the coating layer of the obtained carrier 15 is 1.5%. In addition, the content of a volatile organic compound in the carrier 15 is 330 ppm.

### Preparation of Toner 1

### Preparation of Colorant Particle Dispersion 1

Cyan pigment: 50 parts of C.I. Pigment Blue 15:3 (manufactured by Dainichiseika Color & Chemical Co., Ltd.)
Anionic Surfactant: 5 parts of NEOGEN SC (manufactured by Dai-Ichi Kogyo Seiyaku Co., Ltd.)
Ion exchange water: 200 parts

The above-described components are mixed using ULTRA-TURRAX (manufactured by TKA Japan K.K.) for 5 minutes, followed by dispersion in an ultrasonic bath for 10 minutes. As a result, a colorant particle dispersion 1 having a solid content of 21% is obtained. The volume average particle diameter is 160 nm when measured using a particle size distribution analyzer LA-700 (manufactured by Horiba Ltd.).

### Preparation of Release Agent Particle Dispersion 1

Paraffin Wax: 19 parts of HNP-9 (manufactured by Nippon Seiro Co., Ltd.)
Anionic Surfactant: 1 part of NEOGEN SC (manufactured by Dai-Ichi Kogyo Seiyaku Co., Ltd.)
Ion exchange water: 80 parts

The above-described components are mixed in a heat resistant container, followed by heating to 90° C. and stirring for 30 minutes. Next, the melted solution is passed from the bottom of the container to a Gaulin Homogenizer, and a circulation operation corresponding to three passes is performed under pressure conditions of 5 MPa. A circulation operation corresponding to three passes is further performed under an increased pressure of 35 MPa. An emulsion obtained in this way is cooled to 40° C. or lower in the heat resistant container. As a result, a release agent particle dispersion 1 is obtained. The volume average particle diameter is 240 nm when measured using a particle size distribution analyzer LA-700 (manufactured by Horiba Ltd.).

### Preparation of Resin Particle Dispersion 1 Oil Layer

Styrene (manufactured by Wako Pure Chemical Industries Ltd.): 30 parts
N-butyl acrylate (manufactured by Wako Pure Chemical Industries Ltd.): 10 parts
β-carboxyethyl acrylate (manufactured by Rhodia Nikka. Co., Ltd.): 1.3 parts
Dodecanethiol (manufactured by Wako Pure Chemical Industries Ltd.): 0.4 part

### Water Layer 1

Ion exchange water: 17 parts
Anionic surfactant (DAWFAX2A1, manufactured by The Dow Chemical Company): 0.4 part

### Water Layer 2

Ion exchange water: 40 parts
Anionic surfactant (DAWFAX2A1, manufactured by The Dow Chemical Company): 0.05 part
Ammonium peroxydisulfate (manufactured by Wako Pure Chemical Industries Ltd.): 0.4 part

The above-described components of the oil layer and the above-described components of the water layer 1 are put into a flask, followed by stirring and mixing. As a result, a monomer emulsion dispersion is obtained. The above-described components of the water layer 2 are put into a reaction container, the atmosphere in the container is substituted with nitrogen, and the reaction container is heated until the reaction system reaches 75° C. in an oil bath under stirring. The above-described monomer emulsion dispersion is slowly added dropwise into the reaction container over 3 hours, followed by emulsion polymerization. After finishing the dropwise addition, polymerization is further continued at 75° C. and is finished after 3 hours. As a result, a resin particle dispersion 1 is obtained.

### Preparation of Toner 1

Resin particle dispersion 1: 150 parts
Colorant particle dispersion 1: 30 parts
Release agent particle dispersion 1: 40 parts
Polyaluminum chloride: 0.4 part

The above-described components are mixed and dispersed in a stainless steel flask using ULTRA-TURRAX (manufactured by IKA Japan K.K.). The flask is then heated to 48° C. in a heating oil bath under stirring. The flask is held at 48° C. for 80 minutes, and 70 parts of the resin particle dispersion 1 is added thereto.

Then, after the pH in the system is adjusted to 6.0 using an aqueous sodium hydroxide solution with a concentration of 0.5 mol/L, the stainless steel flask is sealed. A stirring shaft is sealed with a magnetic force, followed by heating to 97° C. under stirring and holding for 3 hours. After the reaction is finished, cooling is performed at a temperature fall rate of 1° C./min, and solid-liquid separation is performed by Nutsche suction filtration. The resultant is redispersed in 3,000 parts of ion exchange water at 40° C., followed by stirring and washing for 15 minutes at 300 rpm. This washing operation is repeated 5 times, and solid-liquid separation is performed by Nutsche suction filtration with NO. 5A filter paper. Next, vacuum drying is continued for 12 hours. As a result, toner particles are obtained.

Silica (SiO₂) particles having a primary average particle diameter of 40 nm of which surfaces are treated to be hydrophobic with hexamethyldisilazane (hereinafter, also referred to as “HMDS”); and metatitanic acid compound particles having a primary average particle diameter of 20 nm which is a reaction product of metatitanic acid and isobutyltrimethoxysilane, are added to the toner particles such that the coverage thereof to the surfaces of the toner particles is 40%, followed by mixing using a Henschel mixer. As a result, a toner 1 is prepared.

### Preparation of Toner 2

101 parts of isophthalic acid, 180 parts of bisphenol A propylene oxide 2 mole adduct, and 5.4 parts of dibutyltin oxide are put into a flask, followed by dehydration condensation at 230° C. in a nitrogen atmosphere for 16 hours. The weight average molecular weight of the obtained polyester resin is 4,800.

174 parts of the polyester resin, 16 parts of the C.I. Pigment Blue 15: 3, and 10 parts of paraffin wax (manufactured by Nippon Seiro Co., Ltd., HNP-9) are put into a Bumbary mixer (manufactured by Kobe Steel Ltd.). The pressure is applied such that the inside temperature is 110±5° C., followed by kneading at 80 rpm for 10 minutes. The obtained kneaded material is cooled and is coarsely pulverized with a hammer mill. The resultant is finely pulverized to approximately 6.8 μm with a jet mill and is classified with an elbow jet classifier (manufactured by Matsuzaka Co., Ltd.) to obtain toner particles. External additives are added to the toner particles with the same method as that of the toner 1. As a result, a toner 2 is prepared.

### Preparation of Developer and Evaluation Therefor

100 parts of the carriers 1 to 15 are respectively mixed with 6 parts of the toners to prepare developers according to Examples 1 to 14 and developers according to Comparative Examples 1 to 4. Using these developers, a printing test is performed using a modified machine of DocuCentre Color 400 (manufactured by Fuji Xerox Co., Ltd.). In a high-temperature and high-humidity environment (30° C., 85% RH), 10,000 images are printed and then evaluation for image quality is performed. In addition, in a low-temperature and low-humidity environment (10° C., 12% RH), 10,000 images are printed and then evaluation for image quality is performed. As the evaluation images, a character chart (test pattern) is used. In addition, the amount of toner deposited is 5.0 g/cm².

A 10,000th printed image is evaluated for image density. Specifically, a case where deterioration in image density is clearly observed by visual inspection is evaluated as C; a case where deterioration in image density is barely observed by visual inspection is evaluated as B; and a case where deterioration in image density is not observed by visual inspection is evaluated as A. The obtained results are shown in Table 1.

In addition, the 10,000th printed image is evaluated for the presence of streaks. Specifically, whether there are streaky defects in the image or not is visually inspected. A case where streaky defects are clearly observed by visual inspection is evaluated as C; a case where streaky defects are barely observed by visual inspection is evaluated as B; and a case where streaky defects are not observed by visual inspection is evaluated as A. The obtained results are shown in Table 1.

When an image is evaluated as C in the high-temperature and high-humidity environment, the image is not evaluated in the low-temperature and low-humidity environment.

TABLE 1

| | | | High-Temperature | | Low-Temperature | |
|---|---|---|---|---|---|---|
| | | | High-Humidity | | Low-Humidity | |
| | | | Image | Presence | Image | Presence |
| | Carrier | Toner | Density | of Streaks | Density | of Streaks |
| Ex. 1 | 1 | 1 | A | A | A | A |
| Ex. 2 | 2 | 1 | A | A | A | A |
| Ex. 3 | 3 | 1 | A | A | A | B |
| Ex. 4 | 4 | 1 | A | A | A | B |
| Ex. 5 | 5 | 1 | A | B | A | B |
| Ex. 6 | 6 | 1 | A | B | A | B |
| Ex. 7 | 7 | 1 | A | B | B | B |
| Ex. 8 | 8 | 1 | A | A | A | A |
| Ex. 9 | 9 | 1 | A | A | B | A |
| Ex. 10 | 13 | 1 | A | A | A | A |
| Ex. 11 | 14 | 1 | A | A | A | A |
| Ex. 12 | 1 | 2 | A | A | A | B |
| Ex. 13 | 13 | 2 | A | A | B | B |
| Ex. 14 | 14 | 2 | A | A | B | B |
| Comp. Ex. 1 | 10 | 1 | C | C | — | — |
| Comp. Ex. 2 | 11 | 1 | C | C | — | — |
| Comp. Ex. 3 | 12 | 1 | B | B | C | B |
| Comp. Ex. 4 | 15 | 1 | B | B | C | B |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier comprising:
a core particle that has a BET specific surface area of from 0.15 m²/g to 0.30 m²/g; and
a coating layer that contains a polycyclohexyl methacrylate resin and has a void ratio of from 2% to 10% and with which the core particle is coated,
wherein a content of a volatile organic compound is less than or equal to 500 ppm.

2. The electrostatic charge image developing carrier according to claim 1,
wherein a ratio of a repeating unit derived from cyclohexyl methacrylate to the polycyclohexyl methacrylate resin is from 50% by mole to 100% by mole.

3. The electrostatic charge image developing carrier according to claim 1,
wherein the polycyclohexyl methacrylate resin has a weight average molecular weight of from 10,000 to 100,000.

4. The electrostatic charge image developing carrier according to claim 1,
wherein the polycyclohexyl methacrylate resin has a weight average molecular weight of from 40,000 to 80,000.

5. The electrostatic charge image developing carrier according to claim 1,
wherein the coating layer further contains a resin selected from a polyolefin resin, an acrylic resin, and a styrene-acrylic resin.

6. The electrostatic charge image developing carrier according to claim 1,
wherein the void ratio of the core particle in the coating layer is from 2% to 9%.

7. The electrostatic charge image developing carrier according to claim 1,
wherein the content of the volatile organic compound is less than or equal to 300 ppm.

8. The electrostatic charge image developing carrier according to claim 1,
wherein the content of the volatile organic compound is greater than or equal to 10 ppm.

9. The electrostatic charge image developing carrier according to claim 1,
wherein the coating layer contains resin particles.

10. The electrostatic charge image developing carrier according to claim 9,
wherein the resin particles are melamine resin particles.

11. An electrostatic charge image developer comprising:
an electrostatic charge image developing carrier; and
an electrostatic charge image developing toner,
wherein the electrostatic charge image developing carrier is the electrostatic charge image developing carrier according to claim 1.

12. A process cartridge, which is detachable from an image forming apparatus, comprising:
at least one selected from the group consisting of a latent image holding member, a charging unit that charges a surface of the latent image holding member, and a cleaning unit that removes toner remaining on the surface of the latent image holding member; and
a developing unit that develops an electrostatic charge image, formed on the surface of the latent image holding member, using an electrostatic charge image developer to form a toner image,
wherein the electrostatic charge image developer is the electrostatic charge image developer according to claim 11.

13. An image forming apparatus comprising:
a latent image holding member;
a charging unit that charges a surface of the latent image holding member;
an electrostatic charge image forming unit that forms an electrostatic charge image on a charged surface of the latent image holding member;
a developing unit that develops the electrostatic charge image using an electrostatic charge image developer to form a toner image;
a transfer unit that transfers the toner image onto a recording medium; and
a fixing unit that fixes the toner image on the recording medium,
wherein the electrostatic charge image developer is the electrostatic charge image developer according to claim 11.

14. An image forming method comprising:
charging a surface of a latent image holding member;
forming an electrostatic charge image on a charged surface of the latent image holding member;
developing the electrostatic charge image using the electrostatic charge image developer according to claim 11 to form a toner image;
transferring the toner image onto a recording medium; and
fixing the toner image on the recording medium.
